(19) United States
(12) Patent Application Publication
(10) Pub. No.: US 2015/0077839 A1
(43) Pub. Date: Mar. 19, 2015

(54) Lens Unit

(71) Applicant: KONICA MINOLTA, INC., Chiyoda-ku (JP)

(72) Inventors: Takahiro Mizukane, Chiyoda-ku (JP); Keiji Arai, Chiyoda-ku (JP); Shuhei Hayakawa, Chiyoda-ku (JP)

(21) Appl. No.: 14/394,001

(22) PCT Filed: Apr. 10, 2013
(86) PCT No.: PCT/JP2013/060780

§ 371 Date: Oct. 10, 2014

(30) Foreign Application Priority Data
Apr. 13, 2012 (JP) 2012-091544

(51) Int. Cl. G02B 13/14; G02B 13/00

(52) U.S. Cl. CPC G02B 13/143; G02B 13/0015
USPC 359/355; 359/740

(57) ABSTRACT

The purpose of the present invention is to provide a lens unit which can create an effective light shield despite the simple process by which the lens unit is produced. A non-transmissive filler (BD) is filled and solidified in the gap between the outer periphery of a light shielding member (SH1) and the outer peripheries of a first lens (L1) and a second lens (L2).

### TECHNICAL FIELD

The present invention relates to a lens unit suitable for imaging lenses and the like.

### BACKGROUND ART

Compact and extremely thin type imaging devices (hereafter, also called a camera module) are employed for mobile terminals such as mobile telephones and PDA, which are compact and thin electric devices, such as mobile telephones and PDA (Personal Digital Assistant). As imaging elements used for these imaging devices, solid state imaging elements such as CCD image sensors and CMOS image sensors are known. In recent years, the imaging elements have been improved to increase the number of pixels, and to attain higher image resolution and higher performance. Further, an imaging lens to form an image of an object on these imaging elements is required to become compact more in response to the miniaturization of imaging elements, and such requirement tends to become stronger from year to year.

As an imaging lens used for the imaging device built in such a mobile terminal, an optical system constituted by resin lenses has been known. Incidentally, in the imaging lens, due to unnecessary reflection, glare, and diffusion in a lens barrel or on a lens end face, ghost and flare may take place. In order to prevent such ghost and flare, there is a technique to dispose between lenses a light shielding member (stop) including an opening to restrict a range to allow light rays to pass through. The positioning of the light shielding member is important, because, if it enters an effective diameter, it itself causes ghost or flare.

PTL (Patent Literature) 1 discloses a technique to utilize a black metal ring as a light shielding member. The advantages of this conventional technique are to make it easy to obtain the positioning accuracy and dimensional accuracy of a light shielding member, and to make it possible to shield light up to a position as near as the end of an effective diameter. However, since a guide for positioning such as a taper and a light shielding member are not likely to deform, a release portion to avoid interference is needed. Accordingly, there is a defect that it is to be disposed only at a limited portion of a lens.

### CITATION LIST

### Patent Literature

PTL1: Japanese Unexamined Patent Application Publication No. 2006-79073 Official Report

PTL2: Japanese Unexamined Patent Application Publication No. 2010-217279 Official Report

### SUMMARY OF INVENTION

### Technical Problem

On the other hand, there is also a technique to use a material other than a solid material such as a black adhesive agent as another light shielding member. According to such a technique, since a light shielding member deforms unlike the above technique, there is an advantage that restrictions in arrangement are few. However, it is difficult to control a position and a thickness due to the fluidity of an adhesive agent. Accordingly, such an adhesive agent tends to invade an effective diameter, which cause poor products. There is a defect that the yield tends to become low.

There is also a technique to avoid such a defect.

PTL2 discloses a technique to form a groove at a position where a light shielding adhesive agent is filled us and to fill the adhesive agent at the groove, thereby making it possible to control the position of the adhesive agent and preventing the lowering of the yield. Further, the height of the adhesive agent filled in the groove is made lower than a surface to come in contact with a lens, whereby dispersion in the thickness of the adhesive agent is made not to influence the accuracy of a position coming in contact with a lens.

Then, the present invention has been achieved in view of the problems of the conventional techniques, and an object of the present invention is to provide a lens unit capable of shielding light effectively in spite of having been produced through simple processes.

### Solution to Problem

A lens unit described in claim 1 includes a first lens, a second lens, an annular light shielding member disposed between the first lens and the second lens, wherein the outer periphery of the light shielding member is disposed at an inside than the outer periphery of the first lens or the second lens, and a non-transmissive filler material is filled up and solidified over a space (region) between the outer periphery of the light shielding member and the outer periphery of the first lens or the second lens.

FIG. 1 is a cross sectional view of a lens unit LU′ according to a comparative example, and FIG. 2 is a cross sectional view of a lens unit LU in this embodiment according to the present invention, which shows a state of being assembled in a not-shown imaging apparatus and in which an object side is an upper side and an image side is a lower side. FIG. 3 is an illustration in which the constitution shown in FIG. 2 is cut along line and is viewed from the arrow direction. The lens unit LU′ of the comparative example shown in FIG. 1 includes a first lens L1, a second lens L2, and an annular light shielding member SH1 arranged between the first lens L1 and the second lens L2, but does not include a filler material. Here, the outer periphery of the light shielding member SH1 is disposed at an inside than the outer periphery of the first lens L1 or the second lens L2, and on the outer periphery of the light shielding member SH1, the flange portion FL1 of the first lens L1 and the flange portion FL2 of the second lens L2 come in contact with each other.

Here, when external light rays OL have invaded the lens unit LU′ from the outside, the external light rays OL are reflected on the image side surface of the first lens L1, then, reflected on the outer periphery of the lens unit LU′, penetrate the flange portions FL1 and FL2, so as to pass through the second lens L2, and escape to the image side. Accordingly, there is a fear that these rays may become ghost and may reduce imaging quality.

On the other hand, in the case of the present invention, a non-transmissive filler material is filled up and solidified over a space between the outer periphery of the light shielding member and the outer periphery of each of the first lens and the second lens. Here, an important thing is that, as shown with hatching in FIG. 3, the filler material BD is brought in contact with the outer peripheral entire periphery of the light shielding member SH1, and brought in contact with the outer peripheral entire periphery of each of the first lens L1 and the second lens L2. If this condition is satisfied, the filler material BD may protrude from the outer periphery of the light shielding member SH1 to an inner side. However, the filler material BD does not protrude from the inner periphery of the light shielding member SH1 to an inner side. It is because there is a fear that if the filler material BD protrudes to an inner side, for example, when the light shielding member SH1 is used as an aperture stop, the function of the light shielding member SH1 cannot be exhibited.

In the case of the present invention, when external light rays OL have invaded from the outside, as shown in FIG. 2, the external light rays OL are reflected on the image side surface of the first lens L1, reflected on the outer periphery of the lens unit LU′, and then, shielded by the filler material BD filled up over a space between the outer periphery of the light shielding member SH1 and the outer periphery of each of the first lens L1 and the second lens L2. Accordingly, since the external light rays OL do not pass to the second lens L2 side, an effect to suppress ghost is high.

FIG. 4 is an illustration showing an enlarged peripheral portion of a lens unit corresponding to the conventional technique of Patent Document 2. In the example shown in FIG. 4, a groove GV is disposed along the entire circumference on the top surface of the flange portion FL2 of the lens and a fluid A is provided in its inside. However, such an operation to pour the fluid A into the groove GV increase one process in the number of processes, and it is necessary to control a filling amount so as not to make the fluid A overflow. Accordingly, there is a problem that time and effort is needed and production cost increases. On the other hand, according to the present invention, unless the filler material BD protrudes from the inner periphery of the light shielding member SH1 to the inside, even if the filler material BD is coated more than needed, there is no problem in the point of the yield, and the reduction of the number of processes can be attained. Further, depending on a case, even if the filler material BD protrudes into the outer periphery of a lens, there is no problem in the point of the function.

Further, in the constitution shown in FIG. 4, since the flange portion FL2 where this groove GV is disposed becomes thinner than other portions, the molding becomes difficult in a lens having been thinned to the limitation. Furthermore, if a groove GV is formed on a lens having been thinned, the strength on the portion of the groove becomes much weaker. Moreover, since the transferring section of the molding die shaped so as to transfer this groove GV becomes a convex, there are problems that the machining to form the convex takes a lot of time and the concentration of the stress on the molding die into the convex shortens the service life of the molding die. On the other hand, according to the present invention, there is no need to dispose a grove to be filled up with a filler material. Accordingly, there are advantages that the production cost of the molding die decreases, the service life of the molding die becomes longer, and the strength of the lens becomes high.

In addition, in the constitution of FIG. 4, since the groove GV cannot be brought in contact with the light shielding member SH1, there is a fear that external light rays OL may pass between them. However, in the present invention, since the filler material BD is brought in contact with the outer peripheral entire periphery of the light shielding member SH1, there is no fear that external light rays OL pass through.

The lens unit described in claim 2 in the invention described in claim 1 is characterized in that the filler material is an adhesive agent to bond the first lens and the second lens.

If a light shielding function can be given to an adhesive agent, the reduction of the number of processes can be attained more.

The lens unit described in claim 3 in the invention described in claim 2 is characterized in that as the adhesive agent, an adhesive agent in which an energy hardenable adhesive agent serving as a base material and carbon black or a metal powder are mixed is used.

When an energy hardenable adhesive agent is used, since it becomes unnecessary to care about the hardening time, handling characteristics becomes excellent. Examples of the energy hardenable adhesive agent include a UV hardenable adhesive agent which is solidified by being irradiating with UV light rays and a heat hardenable adhesive agent which hardens by being heated. Here, an adhesive agent in which a UV hardenable adhesive agent is mixed with carbon etc., becomes difficult to be hardened due to its light shielding properties. However, a heat hardenable adhesive agent has no problem that hardening is obstructed by the light shielding properties, which is desirable. Further, at the time of joining three lenses, even if light shielding portions overlap with each other, it becomes possible to harden them by heating the entire body.

The lens unit described in claim 4 in the invention described in claim 3 is characterized in that the energy hardenable adhesive agent is a UV hardenable adhesive, and when the UV hardenable adhesive is hardened, UV light rays are irradiated from both sides of the optical axis to the UV hardenable adhesive provided between the first lens and the second lens.

As mentioned above, although an adhesive agent in which a UV hardenable adhesive agent is mixed with carbon etc., becomes difficult to be hardened due to its light shielding properties, when UV light rays are irradiated from both sides of the optical axis, it becomes possible to harden the adhesive agent effectively.

The lens unit described in claim 5 in the invention described in claim 3 is characterized in that the energy hardenable adhesive agent is a heat hardenable adhesive. In the case where UV light rays are difficult to reach a portion between lenses, the heat hardenable adhesive is effective.

The lens unit described in claim 5 in the invention described in any one of claims 1 to 4 is characterized in that the first lens and the second lens are bonded each other while a distance between the first lens and the second lens is kept at a predetermined distance.

Even if a filler material is non-transmissive for light, if its thickness is made thin, light tends to permeate through the filler material. In particular, in the state that the first lens and the second lens comes in contact with each other, the thickness of the filler material between them becomes near zero. Then, a distance between the first lens and the second lens is kept at a predetermined distance, whereby the thickness of the filler material filled up between them can be made to a thickness not to allow light to permeate through.

The lens unit described in claim 6 in the invention described in any one of claims 1 to 5 is characterized in that a first lens array including a plurality of the first lenses and a second lens array including a plurality of the second lenses are arranged to face each other and pasted to each other while interposing the light shielding member and the filler material between the first lens and the second lens, and thereafter, the pasted first lens array and second lens array are cut out for each pair of the first lens and the second lens.

With this, a plurality of lens units can be produced in large quantities at low cost.

The lens unit described in claim 7 in the invention described in any one of claims 1 to 6 is characterized in that the lens unit further includes a third lens and an another annular light shielding member disposed between the second lens and the third lens, the outer periphery of the another light shielding member is disposed at an inside than the outer periphery of the second lens or the third lens, and the filler material is filled and solidified over a space between the outer periphery of the light shielding member and the outer periphery of the second lens or the third lens.

With this, it becomes possible to provide a lens unit in which three or more lenses are superimposed in the optical axis direction.

### Advantageous Effects of Invention

According to the present invention, it becomes possible to provide a lens unit capable of shielding light effectively in spite of having been produced through simple processes.

### BRIEF DESCRIPTION OF DRAWINGS

FIG. 1 is a cross sectional view of a lens unit LU′ according to a comparative example to the present invention.

FIG. 2 is a cross sectional view of a lens unit LU according to this embodiment of the present invention.

FIG. 3 is an illustration in which the constitution shown in FIG. 2 is cut along III-III line and is viewed from the arrow direction.

FIG. 4 is an illustration showing an enlarged peripheral portion of a lens unit corresponding to the conventional technique of Patent Document 2.

FIG. 5 is an illustration showing a process of molding a lens array used in this embodiment by using a molding mold, and (a) shows a state that a glass GL is dropped from a nozzle NZ to a lower molding die 20, and (b) shows an upper molding die 10.

FIG. 6 is an illustration showing a process of molding a lens array used in this embodiment by using a molding mold, and shows a state of molding with molding dies.

FIG. 7 is an illustration showing a process of molding a lens array used in this embodiment by using a molding mold, and shows a state after the molding dies are released.

FIG. 8 is a perspective view showing a state after a lens array is released from the molding dies.

FIG. 9 is a perspective view of the front side of a first glass lens array LA1.

FIG. 10 is a perspective view of the back side of the first glass lens array LA1.

FIG. 11 is a cross sectional view of the first glass lens array LA1.

FIG. 12 is a cross-sectional view showing holders HLD and HLD′ to hold the respective back surfaces of the glass lens arrays LA1 and LA1′.

FIG. 13 is a perspective view of the holders HLD and HLD′.

FIG. 14 is a schematic diagram of an apparatus which maintains a predetermined distance between the holder HLD holding the first glass lens array LA1 and the holder HLD′ holding the second glass lens array LA1′.

FIG. 15 is a schematic diagram of processes (a) to (e) by which the first glass lens array LA1 and the second glass lens array LA1′ are pasted together so as to form a lens unit LU.

FIG. 16 is an illustration in which a state shown in FIG. 15(d) is cut along a XVI-XVI line and viewed from the optical axis direction.

FIG. 17 is a perspective view of a lens unit LU.

FIG. 18 is a schematic diagram of processes (a) to (i) by which the first glass lens array LA1, the second glass lens array LA1′, and the third glass lens array LA1″ are pasted together so as to form a lens unit LU.

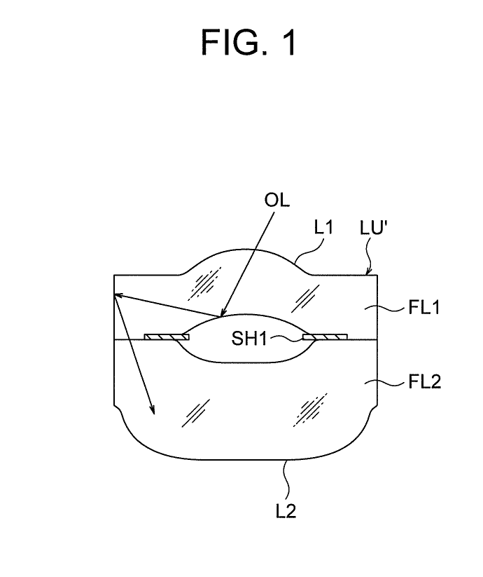

### DESCRIPTION OF EMBODIMENTS

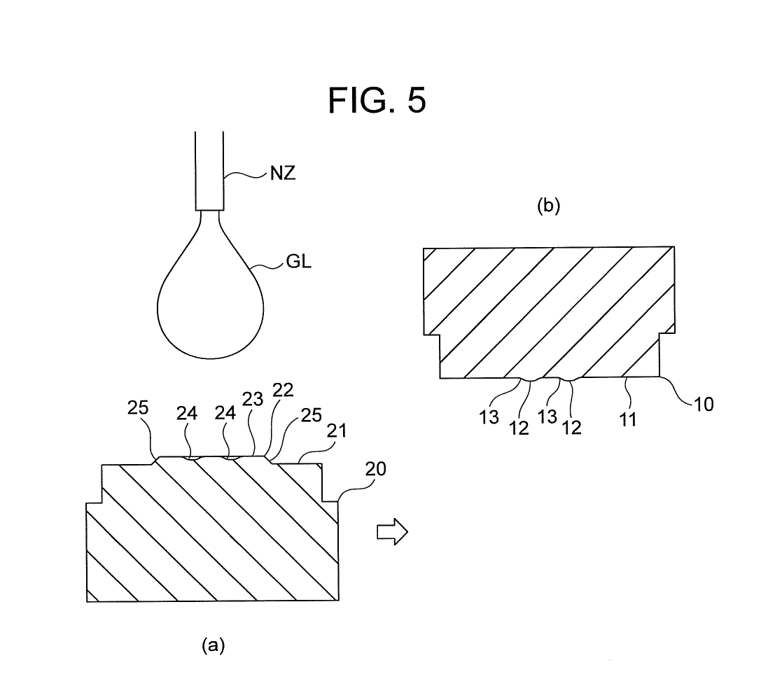

Hereafter, the embodiments of the present invention will be described with reference to drawings. FIGS. 5 to 8 are illustrations showing a process of molding a lens array employed in the present embodiment by using a molding die. On the underside surface (lower surface) 11 of an upper molding die 10, four optical surface transferring surfaces 12 are formed so as to protrude in an arrangement of two rows and two lines. The periphery of each of the optical surface transferring surfaces 12 is shaped in a circular step portion 13 which protrudes by one step from the underside surface 11. The upper molding die 10 is made of a hard and brittle material capable of enduring glass molding, such as ultra-hard alloy and silicon carbide. A below-mentioned lower molding die 20 is similar to the upper molding die 10.

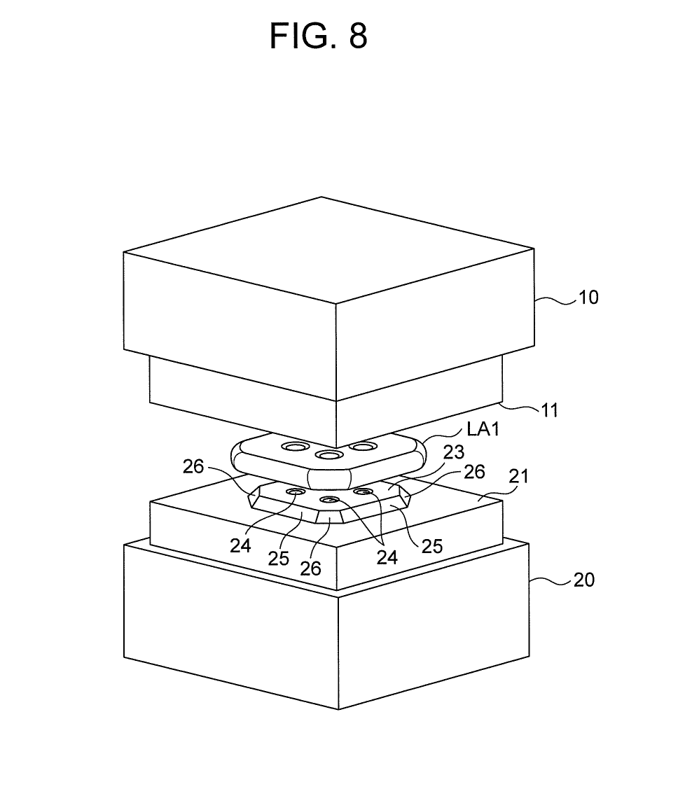

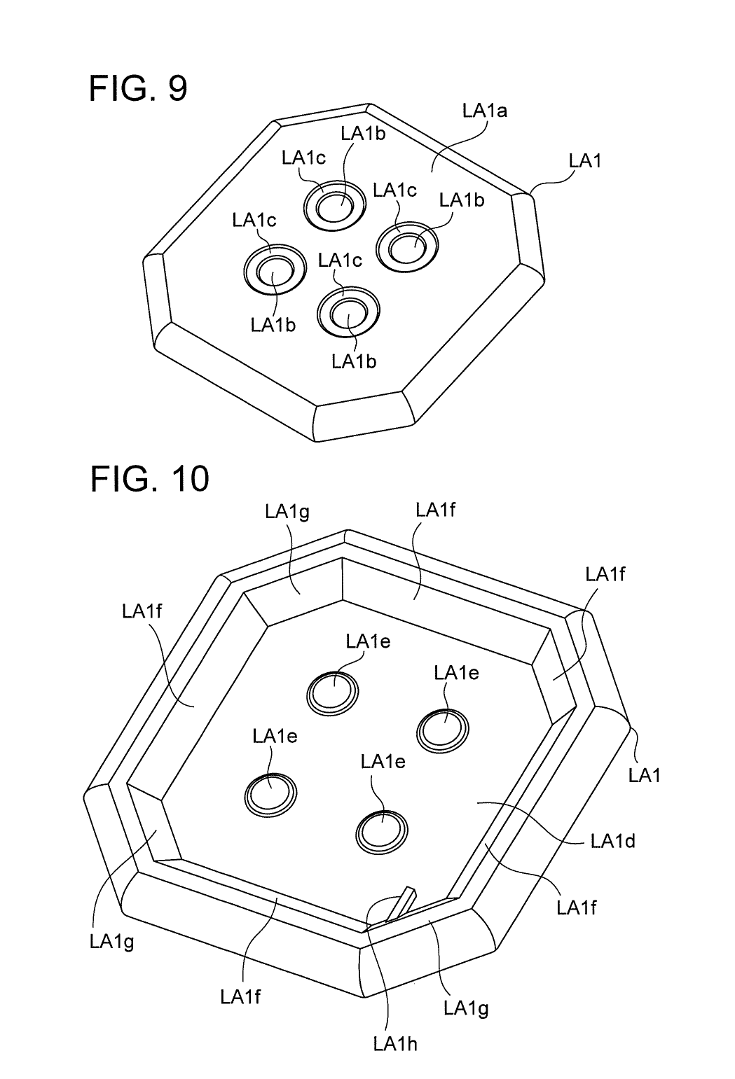

On the other hand, on the top surface 21 of the lower molding die 20, an approximately square-shaped land portion 22 is formed, and on the flat top surface 23 of the land portion 22, four optical surface transferring surfaces 24 are formed so as to become concave in an arrangement of two rows and two lines. On each of the four sides of the land portion 22, a flat surface portion 25 is formed so as to incline at a predetermined angle relative to the respective optical axes of the optical surface transferring surfaces 24. The two flat surface portions 25 which neighbor on each other so as to make the respective axes orthogonal to each other are connected via a corner portion 26 (refer to FIG. 8). Such a flat surface portion 25 can be formed with sufficient accuracy by machining with a milling cutter and the like. On the land portion 22, a concave portion used to transfer a mark to indicate a direction may be disposed. Further, a number used to discriminate each of the optical surface transferring surfaces 24 may be disposed at a position other than the optical surface transferring surfaces 24.

The multiple optical surface transferring surfaces of the molding die can be formed through grinding with a grinding stone by using an ultra-precision processing machine. After the grinding, in order to remove grinding traces, the optical surface transferring surfaces are subjected to polishing so that each of them can be finished into a mirror surface. The positional accuracy of each of optical surfaces can be confirmed such that a distance from the flat surface portion 25 to the optical surface transferring surface 24 and a distance between the two optical surface transferring surfaces 24 are measured with the use of a three-dimensional measuring instrument and the resulting measurements are checked whether to fall within a predetermined specification.

Next, description will be given to the molding of a lens array with reference to FIGS. 5 to 8. In the case where a lens array including a plurality of optical surfaces is collectively molded by press-molding between the molding dies, any one of the following two methods may be employed.

In the first method (1), as with the conventional glass lens molding, a preform is preliminarily prepared so as to be shaped in an approximate form of a lens portion. A plurality of such preforms are separately arranged on the respective molding surfaces of a molding die and molded by heating and cooling.

In the second method (2), a liquefied molten glass is dropped from an upper portion onto the molding surface and molded by cooling without heating.

In this embodiment, in view of a constitution configured to mold a glass lens array, it is preferable to employ the second method (2). The reason is that the second method (2) makes it possible to enlarge a difference in thickness between a lens portion and a non-lens portion (a portion between two lenses in a plurality of lenses or a portion forming an end portion of an intermediate fabrication component). Further, according to a preferable method, it is preferable to drop collectively a large glass droplet, i.e., a molten glass droplet with a volume capable of being filled sufficiently into at least two molding surfaces without dropping a glass droplet separately into each molding surface. Furthermore, according to a more preferable method, a dropping position is determined so as to drop a large molten glass droplet at a position located with an equal distance from each of a plurality of molding surfaces expected to be filled with a glass droplet. With the employment of the above methods, it becomes possible to minimize a time difference among the respective time periods of the molding surfaces to take for being filled separately with a glass droplet. Accordingly, it becomes possible to minimize a shape difference among the molded lens shapes and a bad influence to optical performance. Naturally, in consideration of the above time difference, small glass droplets may be dropped separately simultaneously into respective molding surfaces, thereby attaining the similar effects. However, in order to make glass into such small glass droplets, an apparatus becomes large and complicate in terms of constitution. Accordingly, the former is more preferable.

Namely, in the case of a large droplet in the former, as shown in FIG. 5(a), the lower molding die 20 is located beneath a platinum nozzle NZ which communicates with a storage section (not-shown) which stores heated molten glass, and a liquid droplet of the molten glass GL is dropped collectively from the platinum nozzle NZ toward a position on the top surface 21 which is located with an equal distance from each of the plurality of optical surface transferring surfaces 24. In this state, since the viscosity of the glass GL is low, the dropped glass GL spreads on the top surface 21 so as to wrap up the land portion 22 so that the shape of the land portion 22 is transferred onto the glass GL. Further, in the case of dropping separately small liquid droplets in the latter, a comparatively-large liquid droplet of the glass GL is made to pass through four small holes so as to be separated into four small liquid droplets while adjusting the quantity of each liquid droplet, and the four small liquid droplets are fed separately approximately simultaneously onto the top surface 21. When liquefied molten glass is dropped, since an air pocket tends to take place among the respective molding surfaces, it is necessary to consider sufficiently the dropping condition to drop the molten glass such as volume.

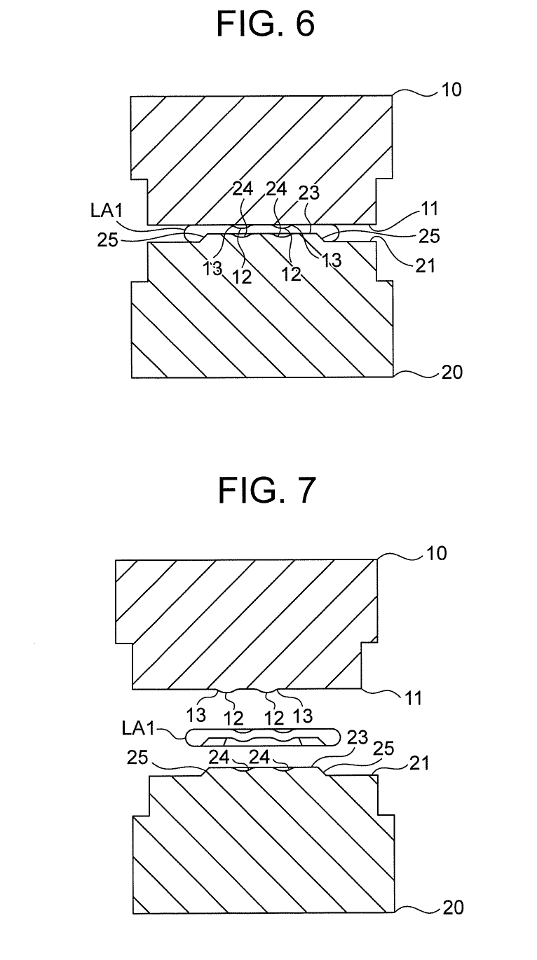

Successively, before the glass GL cools, the lower molding die 20 is made approach a position which is located beneath the upper molding die 10 shown in FIG. 5 (b) and faces the upper molding die 10, and the lower molding die 20 is aligned with the upper molding die 10. Further, as shown in FIG. 6, molding is performed by making the upper molding die 10 and the lower molding die 20 approach each other with the use of a not-shown guide. With this operation, onto the top surface of the flattened glass GL, the optical surface transferring surfaces 12 and the circular step portions 13 of the upper molding die 10 are transferred, and onto its bottom surface, the shape of the land portion 22 of the lower molding die 20 is transferred. At this time, while the underside surface 11 of the upper molding die 10 and the top surface 21 of the lower molding die 20 are held in parallel to each other and separated from each other with a predetermined distance, the glass GL is made cool. The glass GL solidifies in the state that the glass GL is flattened so as to surround around the periphery and the shape of the flat surface portion 25 is transferred onto the glass GL.

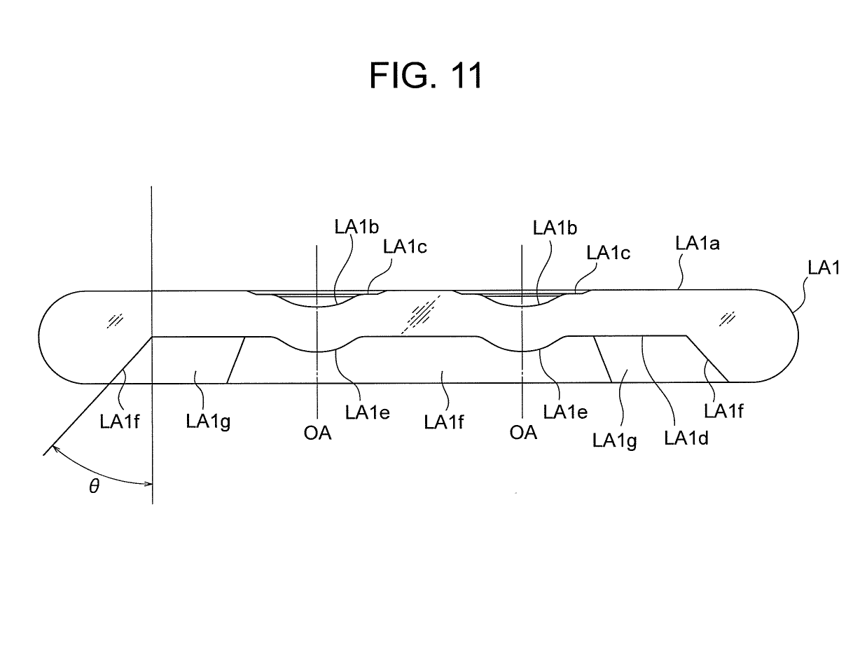

Subsequently, as shown in FIGS. 7 and 8, the upper molding die 10 and the lower molding die 20 is made to separate from each other, and the glass GL is taken out, thereby forming a glass lens array LA1. FIG. 9 is a perspective view of the front side of the glass lens array LA1, and FIG. 10 is a perspective view of its back side. Further, FIG. 11 is a cross-sectional view of the glass lens array LA1 at a position including the optical axis.

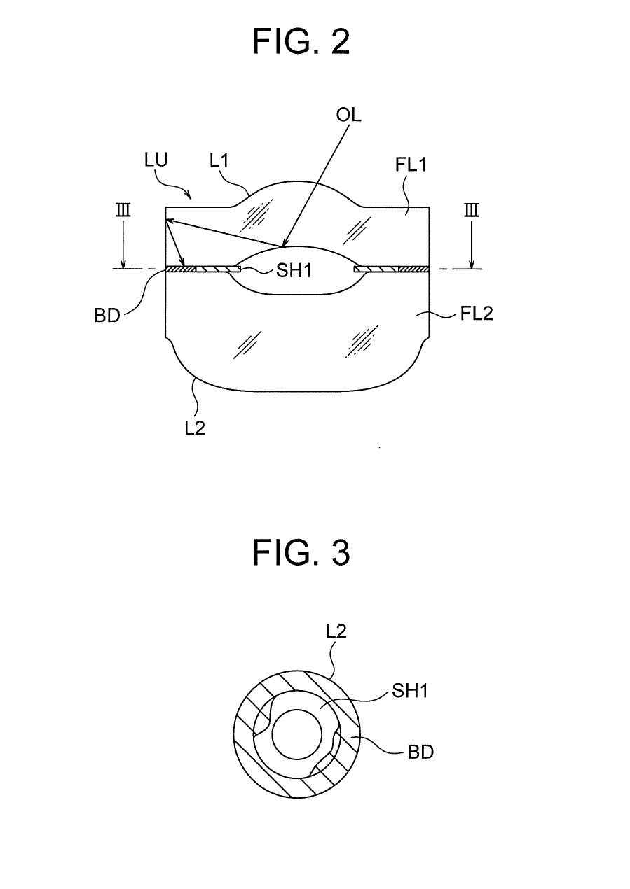

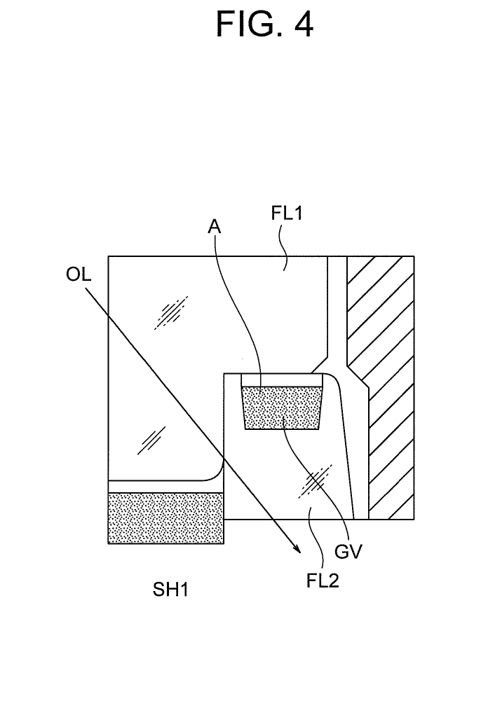

As shown in the drawings, the glass lens array LA1 is shaped in a thin square (or octagon) plate as a whole. The glass lens array LA1 includes a top surface LA1a which is transferred and molded from the underside surface 11 of the upper molding die 10 and is a highly precise flat surface; four concave optical surfaces LA1b which are transferred from the optical surface transferring surfaces 12 onto the top surface LA1a; and shallow circular grooves LA1c which are transferred from the circular step portions 13 to the respective peripheries of the concave optical surfaces LA1b. The circular grooves LA1c are used, for example, to accommodate respective light shielding members SH (refer to FIG. 2).

Further, the glass lens array LA1 includes a bottom surface LA1d which is transferred from the top surface 23 of the land portion 22 of the lower molding die 20 and is a highly precise flat surface; four convex optical surfaces LA1e which are transferred and molded from the optical surface transferring surface 24 onto the bottom surface LA1d, and first flat surfaces LA1f and corner connecting portions LA1g which are transferred respectively from the flat surface portions 25 and the corner portions 26 of the land portion 22. A reference symbol LA1h represents a mark which is transferred simultaneously and indicates a direction. The first flat surfaces LA1f and the corner connecting portions LA1g constitute an inner peripheral surface.

In FIG. 11, each of the first flat surfaces LA1f is made incline at an angle of 10° to 60° (here, 45°) with respect to each of the respective optical axes OA of the optical surfaces.

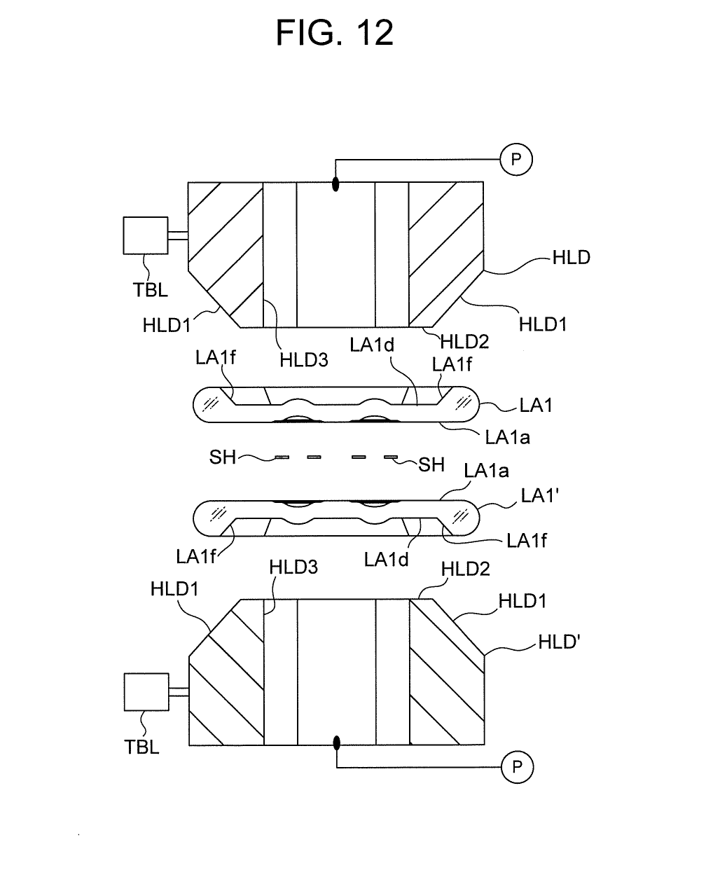

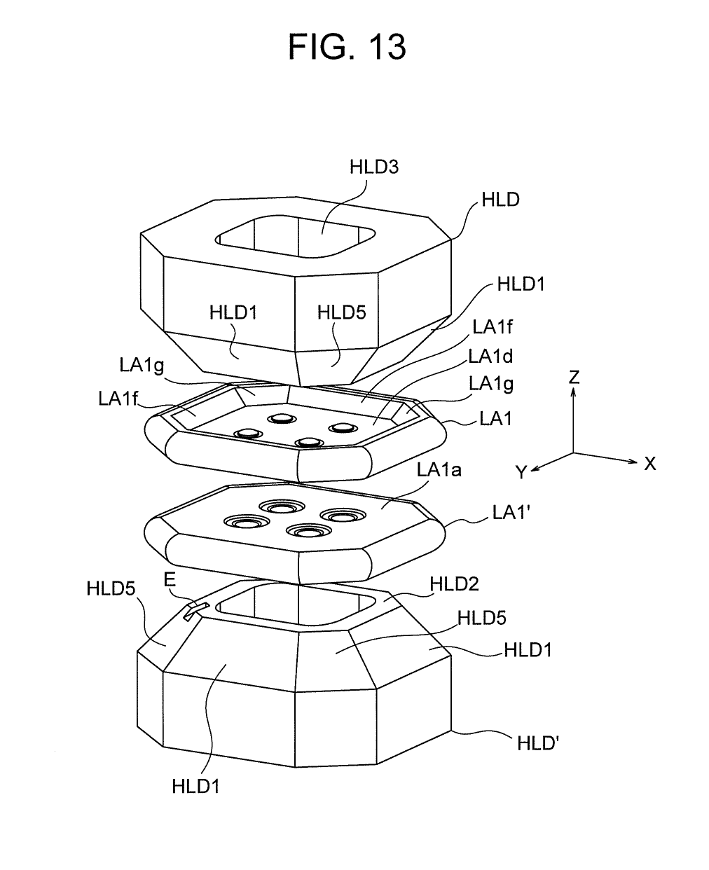

Next, description will be given to a process of forming an intermediate fabrication component 1M by pasting a glass lens array molded separately in the similar manner to that of the glass lens array LA1 onto the glass lens array LA1. FIG. 12 is a cross-sectional view showing holders HLD and HLD′ to hold the respective back surfaces of the glass lens arrays LA1 and LA1′, and FIG. 13 is a perspective view. The holders HLD and HLD′ are mounted on a XYZ table TBL (not-shown) capable of moving three dimensionally. Here, it is presupposed that a direction along the optical axis of the optical surface is made a Z direction, and directions orthogonal to the Z direction are made an X direction and a Y direction respectively.

The holder HLD and HLD′ each shaped in a rectangular barrel includes tapered surfaces HLD1 on its external periphery at the holding side and end surfaces HLD2 which intersects with the respective tapered surfaces HLD1. The tapered surfaces HLD1 each of which serves as a second flat surface are provided by four in response to the number of the first flat surfaces LA1f of the glass lens array LA1, and each of the tapered surfaces HLD1 is made incline by 45° with respect to the axis of the central opening HLD3 of the holder HLD. The central opening HLD3 has a size capable of surrounding the optical surfaces LA1e of the glass lens array LA1. Therefore, the end surfaces HLD2 are enabled to come in contact with the bottom surface LA1d of the glass lens array LA1. The back surface side of the central opening HLD3 is connected to a negative pressure source P. Here, the two tapered surfaces HLD1 neighboring on each other are connected via a corner tapered surface HLD5. The tapered surfaces HLD1 and the corner tapered surfaces HLD5 constitute an outer peripheral surface. It may be preferable to form an escape portion (concave portion) E configured to receive the mark LA1h at a part from one of the end faces HLD2 to one of the corner tapered surfaces HLD5.

It is preferable that each of the holders HLD and HLD′ is made of a stainless material, and subjected to quenching treatment in order to suppress abrasion and deformation, whereby hardness is made HRC 56 or more. Further with regard to a distance between the two tapered surfaces HLD1 facing each other, an amount of shrinkage at the time of molding of a lens array is calculated, and then the distance is preferably determined in consideration of the amount of shrinkage as a feedback value.

From the state shown in FIGS. 12 and 13, when the holder HLD is made approach the glass lens array LA1, the end surfaces HLD2 are brought in contact with the bottom surface LA1d of the glass lens array LA1. In this state, when the inside of the central opening HLD3 is made into a negative pressure, the glass lens array LA1 is adsorbed and held by the holder HLD. In this state, the first flat surfaces LA1f of the glass lens arrays LA1 face the respective tapered surfaces HLD1 of the holder HLD with a clearance Δ of 10 μm or less (for example, 2 μm)(refer to FIG. 10), or come in contact with the respective tapered surfaces HLD1. Further, the corner connecting portions LA1g face the respective corner tapered surfaces HLD5 with a clearance equal to or more than the above clearance.

When the first flat surfaces LA1f come in contact with the respective tapered surfaces HLD1, the glass lens array LA1 cannot rotate more than that for the holder HLD. Meanwhile, since the tapered surfaces HLD1 are regulated by the respective opposite first flat surface LA1f, the glass lens array LA1 cannot move more than that relatively to the holder HLD. That is, by holding the glass lens array LA1 with the holder HLD, the glass lens array LA1 can be positioned with high precision for the holder HLD. Therefore, by positioning the two holders HLD to each other with high precision with the XYZ table TBL, the two glass lens arrays LA1 held respectively by the two holders HLD can be positioned to each other with high precision while facing each other. As a result, with this positioning, all the four optical surfaces can be aligned with high precision.

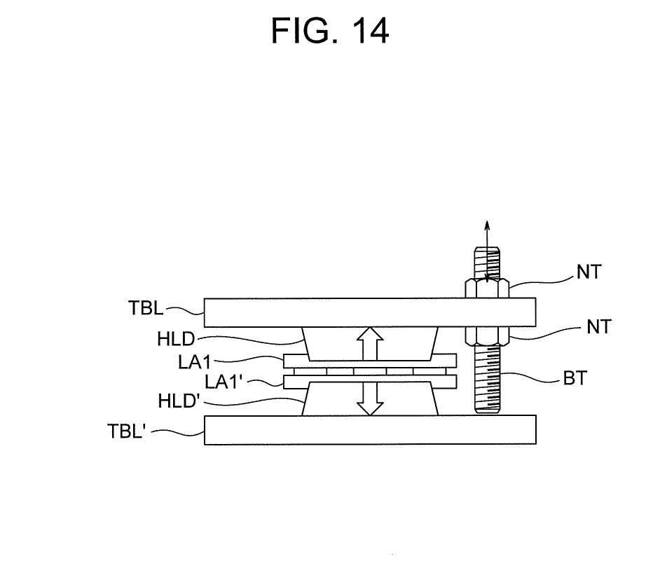

FIG. 14 is a schematic diagram of an apparatus which maintains a predetermined distance between the holder HLD holding the first glass lens array LA1 and the holder HLD′ holding the second glass lens array LA1′. A bolt BT is screwed into a shifting XYZ table TBL which secures the holder HLD and is movable in the vertical direction. The lower end of the Bolt BT is brought in contact with the top surface of a fixed XYZ table TBL′ which secures the holder HLD′.

When the bolt BT is rotated relatively to the shifting XYZ table TBL, the lower end of Bolt BT moves vertically, whereby a distance between the holder HLD and the HLD′ changes. Accordingly, a distance between the first glass lens array LA1 and the second glass lens array LA1′ can be maintained at a predetermined distance. A lock nut NT is used to secure the bolt BT with a set pushed-out length to the shifting XYZ table TBL. With the above constitution, the film thickness of a light-shielding adhesive agent BD (later-mentioned) can be managed.

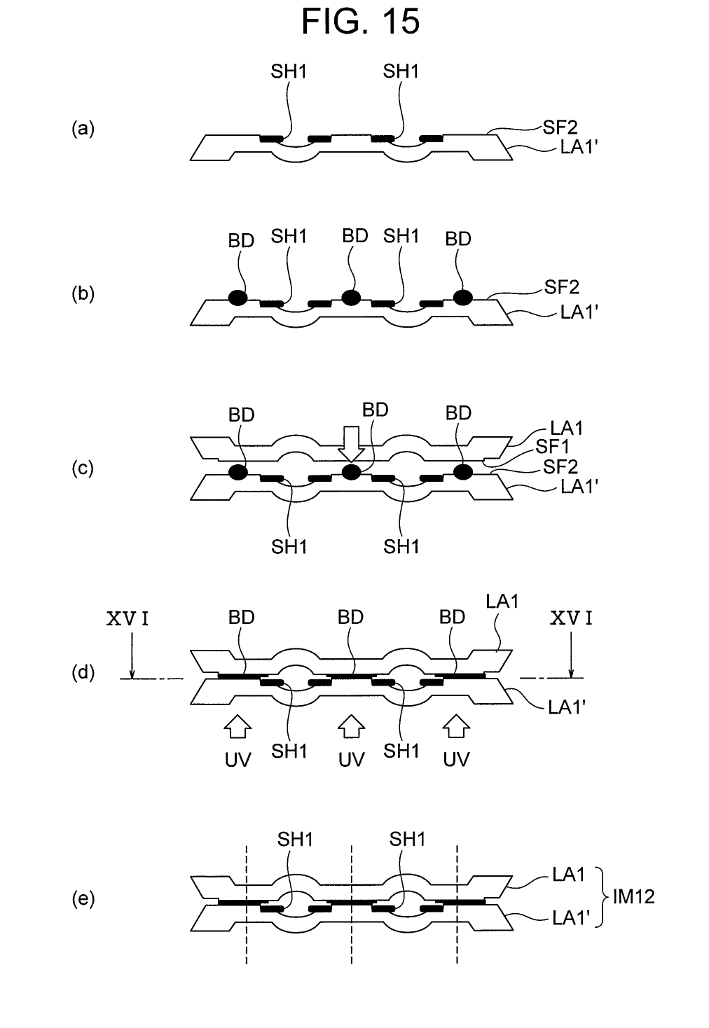

FIG. 15 is a schematic diagram of processes (a) to (e) by which the first glass lens array LA1 and the second glass lens array LA1′ are pasted together with each other so as to form a lens unit LU. Here, the illustration of each of the holders HLD and HLD′ is omitted. A 304 type stainless steel serving as a raw material is colored with black, and then the colored stainless steel is used as the light shielding member SH1.

First, as shown in FIG. 15(a), four light shielding members SH1 each shaped in a doughnut plate are arranged in conformity with the respective lens sections of the second glass lens array LA1′ held by the holder (not-shown). Here, since four shallow concave portions (LA1c in FIG. 11) each having a tapered inner periphery surface are formed on the second glass lens array LA1′, the centering of each of the light shielding members SH1 can be performed based on them.

Subsequently, as shown in FIG. 15(b), a proper amount of a UV hardenable light shielding adhesive agent BD (for example, Product Name: “World Lock” manufactured by Kyoritsu Chemical & Co., Ltd.) is coated on the surface SF2 of the second glass lens array LA1′. Successively, as shown in FIG. 15(c), the surface SF1 of the first glass lens array LA1 which is held precisely by the holder (not-shown) mounted on the shifting stage is made to face the surface SF2 of the second glass lens array LA1′, and is made to approach to the surface SF2 up to a predetermined distance (a gap of about 5 μm between lenses) by using the apparatus shown in FIG. 14. Here, as the light shielding adhesive agent BD, a heat hardenable adhesive agent may be used.

Subsequently, as shown in FIG. 15(d), UV light rays are irradiated from the underside surface of the second glass lens array LA1′. Here, in addition to this, UV light rays may be irradiated from the top surface side of the first glass lens array LA1. With this, the light shielding adhesive agent BD is solidified.

FIG. 16 is an illustration in which a state shown in FIG. 15(d) is cut along a XVI-XVI line and viewed from the optical axis direction. As shown with hatching in FIG. 16, a light shielding filler material BD is brought in contact with the outer peripheral entire periphery of each of the four light shielding members SH1. Here, the light shielding filler material BD has not reached the outer periphery of the second glass lens array LA1′. However, as mentioned later, the glass lens arrays LA1 and LA1′ are cut out along dotted lines (FIG. 15 (e)), and separated into lens units. Accordingly, if the light shielding filler material BD is filled up to cut-out positions, the light shielding filler material BD is enough to form the lens units. That is, cut-out positions become respective outer peripheries of the lens units.

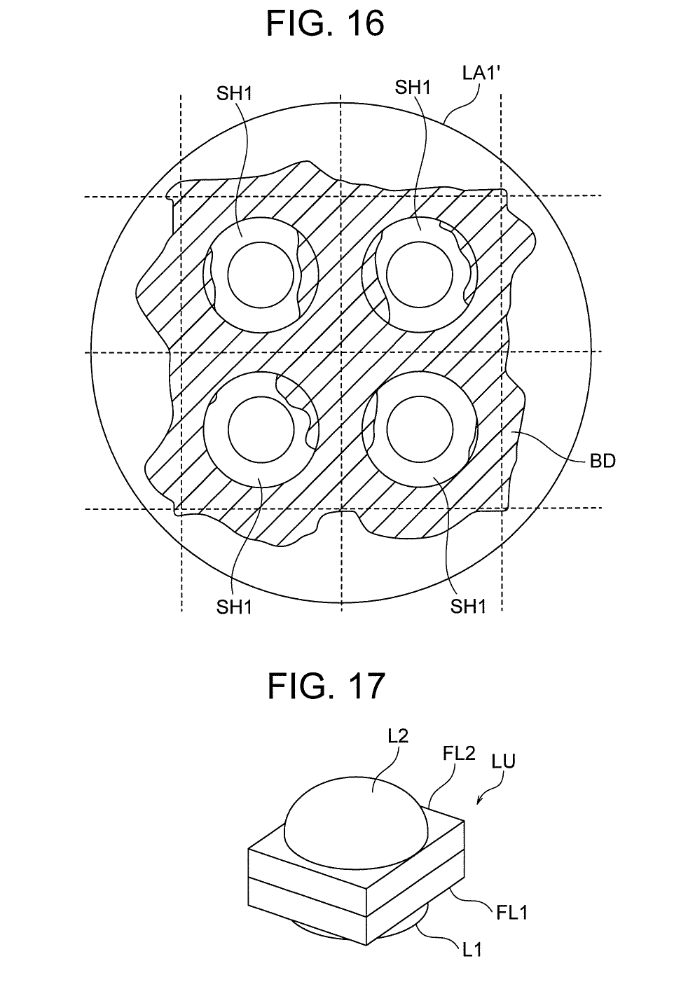

After the adhesive agent was solidified, as shown in FIG. 15(e), the absorption of the upper holder is stopped, and the upper holder is separated away, whereby a lens array body IM12 held at the lower holder can be taken out. Successively, the lens array body IM12 is cut out along dotted lines with a not-shown dicing blade, whereby it becomes possible to obtain a lens unit sown in FIG. 17. The lens unit LU includes the first lens L1, the second lens L2, and the light shielding member SH1 disposed between the first lens L1 and the second lens L2, and, the light shielding filler material BD is filled up at the outer periphery of each of the light shielding member SH1 and the lens unit LU. In the case where each of the flange portion FL1 of the first lens L1 and the flange portion FL2 of the second lens L2 is shaped in a rectangular form, since superfluous potions are formed at the four corners, external light rays tend to invade. Accordingly, the effects of the present invention can be exhibited particularly.

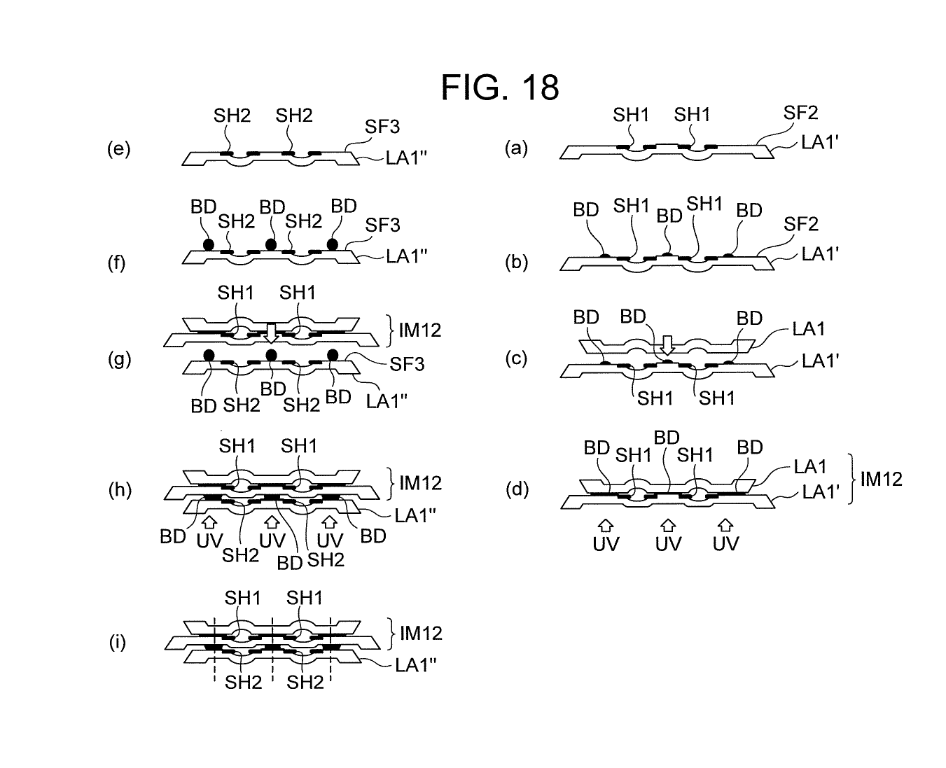

FIG. 18 is a schematic diagram of processes (a) to (i) of pasting the first glass lens array LA1, the second glass lens array LA1′, and the third glass lens array LA1″ together so as form lens units LU.

Since FIGS. 18(a) to 18(d) are equivalent to the processes from FIGS. 15(a) to 15(d), descriptions for them are omitted. Apart from these processes, the third glass lens array LA1″ is produced. Successively, as shown in FIG. 18(e), four light shielding members SH2 each shaped in a doughnut plate are arranged in conformity with the respective lens sections of the third glass lens array LA1″ held by the holder (not-shown). Here, since four shallow concave portions each having a tapered inner periphery surface are formed on the third glass lens array LA1′, the centering of each of the light shielding members SH2 can be performed based on them.

Subsequently, as shown in FIG. 18(f), a proper amount of a UV hardenable light shielding adhesive agent BD is coated on the surface SF3 of the third glass lens array LA1″. Successively, as shown in FIG. 18(g), the lens array body IM12 is made to face the surface SF3 of the third glass lens array LA3 which is held precisely by the holder (not-shown), and is made to approach to it up to a predetermined distance (a gap of about 5 μm between lenses) by using the apparatus shown in FIG. 14.

Subsequently, as shown in FIG. 18(h), UV light rays are irradiated from the underside surface of the third glass lens array LA1″, and the UV light rays reach the light shielding adhesive agent BD filled up on the surface SF3 of the third glass lens array LA1″ without being interrupted. With this, the light shielding adhesive agent BD is solidified.

After the adhesive agent was solidified, as shown in FIG. 18(i), the absorption of the upper holder is stopped, and the upper holder is separated away, whereby the third glass lens array LA1″ held at the lower holder can be taken out. Successively, the third glass lens array LA1″ is cut out along dotted lines with a not-shown dicing blade, whereby it becomes possible to obtain a lens unit with a three lens constitution.

It is clear for a person skilled in the art from the embodiment and technical concept described in this description that the present invention should not be limited to the embodiments described in the description and includes other modified embodiments.

### REFERENCE SIGNS LIST

10 Upper Mold
11 Underside Surface
12 Optical Surface Transferring Surface
13 Circular Step Portion
20 Lower Mold
21 Top Surface
22 Land Portion
23 Top Surface
24 Optical Surface Transferring Surface
25 Flat Surface Portion
26 Corner Portion
40 Mirror Frame
40a Flange portion
40b Opening
40c Inner Peripheral Surface
LU Lens unit
FL1 Rectangular Plate-shaped Flange
FL2 Rectangular Plate-shaped Flange
LA1 First Glass Lens Array
LA1′ Second Glass Lens Array
LA1″ Third Glass Lens Array
LA1b Concave Optical Surface
LA1c Circular groove
LA1d Bottom Surface
LA1e Optical Surface
LA1e Convex Optical Surface
LA1f Flat Surface
LA1g Corner Linking Portion
IM12 Lens Array Body
HLD, HLD′ Holder
HLD1 Tapered Surface
HLD2 End Face
HLD3 Central Opening
HLD4 Roll-off
HLD5 Corner Tapered Surface
NZ Platinum Nozzle
SH1, SH2 Light shielding member

1. A lens unit, comprising:
a first lens;
a second lens; and
an annular light shielding member disposed between the first lens and the second lens,
wherein an outer periphery of the light shielding member is disposed at an inside than an outer periphery of the first lens or the second lens, and a non-transmissive filler material is filled up and solidified so as to contact with the outer peripheral entire periphery of the light shield member and to contact with the outer peripheral entire periphery of the first lens or the second lens.

2. The lens unit described in claim 1, wherein the filler material is an adhesive agent to bond the first lens and the second lens.

3. The lens unit described in claim 2, wherein as the adhesive agent, an adhesive agent in which an energy hardenable adhesive agent serving as a base material and carbon black or a metal powder are mixed is used.

4. The lens unit described in claim 3, wherein the energy hardenable adhesive agent is a UV hardenable adhesive, and when the UV hardenable adhesive is hardened, UV light rays are irradiated from both sides of an optical axis to the UV hardenable adhesive provided between the first lens and the second lens.

5. The lens unit described in claim 3, wherein the energy hardenable adhesive agent is a heat hardenable adhesive.

6. The lens unit described in claim 1, wherein the first lens and the second lens are bonded each other while a distance between the first lens and the second lens is kept at a predetermined distance.

7. The lens unit described in claim 1, wherein a first lens array including a plurality of the first lenses and a second lens array including a plurality of the second lenses are arranged to face each other and pasted to each other while interposing the light shielding member and the filler material between the first lens and the second lens, and thereafter, the pasted first lens array and second lens array are cut out for each pair of the first lens and the second lens.

8. The lens unit described in claim 1, wherein the lens unit further includes a third lens and an another annular light shielding member disposed between the second lens and the third lens, the outer periphery of the another light shielding member is disposed at an inside than the outer periphery of the second lens or the third lens, and the filler material is filled up and solidified over a space between the outer periphery of the light shielding member and the outer periphery of the second lens or the third lens.
